(19) United States
(12) Patent Application Publication
(10) Pub. No.: US 2021/0049452 A1
(43) Pub. Date: Feb. 18, 2021

(54) CONVOLUTIONAL RECURRENT GENERATIVE ADVERSARIAL NETWORK FOR ANOMALY DETECTION

(71) Applicant: INTUIT INC., Mountain View, CA (US)

(72) Inventors: Zhewen FAN, San Diego, CA (US); Farzaneh KHOSHNEVISAN, San Diego, CA (US)

(73) Assignee: INTUIT INC., Mountain View, CA (US)

(21) Appl. No.: 16/985,467

(22) Filed: Aug. 5, 2020

Related U.S. Application Data
(60) Provisional application No. 62/887,247, filed on Aug. 15, 2019.

(51) Int. Cl. G06N 3/063; G06N 3/08; G06N 3/04; G06F 11/07

(52) U.S. Cl. CPC G06N 3/063; G06N 3/08; G06F 11/079; G06F 11/0793; G06N 3/049

(57) ABSTRACT

An anomaly detection service executed by a processor may receive multivariate time series data and format the multivariate time series data into a final input shape configured for processing by a generative adversarial network (GAN). The anomaly detection service may generate a residual matrix by applying the final input shape to a generator of the GAN, the residual matrix comprising a plurality of tiles. The anomaly detecting service may score the residual matrix by identifying at least one tile of the plurality of tiles having a value beyond a threshold indicating an anomaly. The processor may perform at least one remedial action for the anomaly in response to the scoring.

### CROSS-REFERENCE TO RELATED APPLICATIONS

This application claims the benefit and priority of U.S. Application No. 62/887,247, filed on Aug. 15, 2019, entitled CONVOLUTIONAL RECURRENT GENERATIVE ADVERSARIAL NETWORK FOR ANOMALY DETECTION, the contents of which are fully incorporated herein by reference as though set forth in full.

### BACKGROUND OF THE DISCLOSURE

Generative Adversarial Networks (GANs) are machine learning networks often used in the computer vision domain, where they are known to provide superior performance in detecting image anomalies. Application of GANs to other types of data processing is less common.

At the same time, existing methods for detecting anomalies in multivariate data sets may often provide disappointing performance in adjusting for seasonal patterns in the data sets, dealing with contamination in the data sets, detecting instantaneous anomalies in time series data sets, and/or identifying root causes of anomalies that are detected.

### BRIEF DESCRIPTION OF THE FIGURES

FIG. 1 shows a service ecosystem according to an embodiment of the present disclosure.

FIGS. 2A-2B show a generative adversarial network according to an embodiment of the present disclosure.

FIGS. 3A-3B show input data format processing according to an embodiment of the present disclosure.

FIGS. 4A-4B show a generative adversarial network configured to be robust against noise according to an embodiment of the present disclosure.

FIG. 5 shows a generator of a generative adversarial network including an attention mechanism according to an embodiment of the present disclosure.

FIGS. 6A-6B show an attention mechanism according to an embodiment of the present disclosure.

FIGS. 7A-7D describe a Wasserstein function used by a discriminator of a generative adversarial network according to an embodiment of the present disclosure.

FIGS. 8A-8C show anomaly score assignment and root cause identification according to an embodiment of the present disclosure.

FIG. 9 shows an anomaly detection process according to an embodiment of the present disclosure.

FIG. 10 shows a computing device according to an embodiment of the present disclosure.

### DETAILED DESCRIPTION OF SEVERAL EMBODIMENTS

Embodiments described herein may extend the use of GANs to multivariate time series anomaly detection. For example, time series data may be converted to image like structures that can be analyzed using a GAN. The GAN architecture itself may be revamped to include an attention mechanism, and the results of GAN processing may be assessed using an anomaly scoring algorithm. As a result, embodiments described herein may be capable of handling seasonalities, may be robust to contaminated training data, may be sensitive to instantaneous anomalies, and may be capable of identifying causality (root cause).

By applying the embodiments described herein, GAN may be used to detect anomalies in any multivariate time series data. For example, disclosed embodiments may be applied to detect anomalies in network traffic or computer system performance quickly and accurately, including root cause detection with high sensitivity and precision, allowing such anomalies to be addressed or mitigated faster and with less intermediate investigation than using other anomaly detection technologies. However, while some embodiments described herein function as components of software anomaly detection systems and/or services, the disclosed embodiments may be applied to any kind of multivariate time series data analysis.

To begin, multivariate time series data may be prepared for input to the GAN, for training and/or for analysis. It may be a non-trivial task to input raw multivariate time series data into a GAN, because GAN is originally designed for image tasks. Accordingly, as described in detail below, embodiments described herein may transform raw time-series data into an image-like structure (a “signature matrix”). Specifically, disclosed embodiments may consider three windows of different sizes. At each time step, the pairwise inner products of the time series within each window may be calculated, resulting in n×n images in 3 channels. In some embodiments, as further input to the GAN model, previous h steps may be appended to each time step to capture the temporal dependencies unique to the time series.

As described in detail below, given a set of training data formulated for input into the GAN model, the model may be trained to allow the model to perform analysis on data of interest. Training may proceed as follows in some embodiments. First, the GAN model may be provisioned. As described in detail below, the GAN model may include a generator component configured to generate fake data and a discriminator component configured to compare the fake data to real data. These elements may be trained in parallel. The generator may have an internal encoder-decoder structure that includes multiple convolutional layers. The encoder itself may include convolutional long short-term memory (LSTM) gates. Therefore, the model may be capable of capturing both spatial and temporal dependencies in the input, as described below. In order to capture seasonalities that may be present in data, previous seasonal steps may be appended to the input. By adding an attention component to the convolutional LSTM, the GAN model may capture the seasonal dependencies. Additionally, smoothing may be performed by taking averages in a neighboring window, to account for shifts in the seasonal patterns. Simultaneously training a separate encoder and the generator may help the generator become more robust to noise and contaminations in training data, as described in detail below. Because GAN model training is known to be unstable if not designed properly, embodiments described in detail below may apply “Wasserstein GAN with Gradient Penalty” to insure the stability and convergence of the model.

After the GAN model is trained, the model artifacts may be fixed in network components, and the model may be ready for testing of incoming data. For example, the model may be run on each batch in the output of a sample test set of interest. Anomaly scores may be assigned based on generated losses, as described in detail below. As opposed to other methods that assign anomaly scores based on an absolute loss value, embodiments described herein may discretize a scoring function to magnify the effect of anomalies. For example, the number of broken tiles (elements of a residual matrix that are indicative of being anomalous) may be counted only if more than half of the tiles in a row or column are broken. Furthermore, since each row and/or column of the residual matrix may be associated with a time series, rows and/or columns with larger errors (or more broken tiles) may be identified as indicating the root cause of a detected anomaly in some embodiments.

Accordingly, embodiments described herein may improve anomaly detection by applying GAN with simultaneous training of an encoder to a multivariate time series in order to handle contaminated data, by accounting for seasonality in the data using an attention mechanism and smoothing based on a neighboring window, and scoring based on a magnitude of errors in a residual matrix to help identify a root cause and/or to increase scoring sensitivity. At which point, a remedial action may be undertaken for the anomaly in response to the scoring.

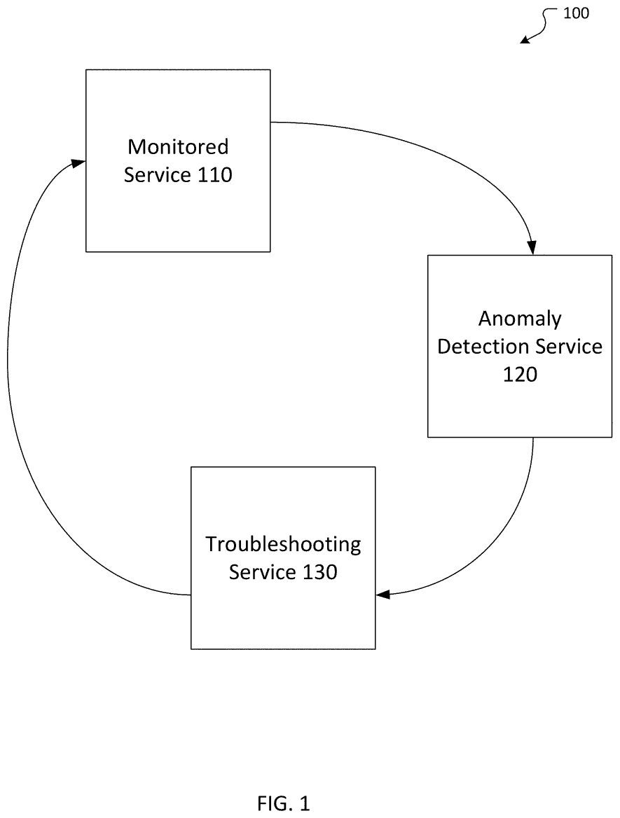

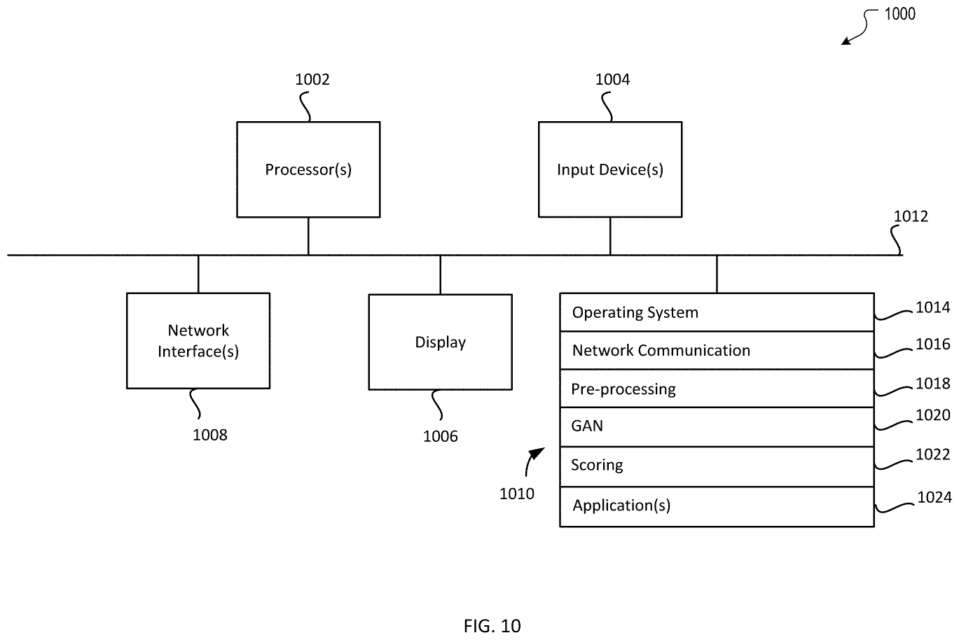

FIG. 1 shows a service ecosystem 100 according to an embodiment of the present disclosure. Ecosystem 100 may include one or more devices or components thereof in communication with one another. These devices or components may include elements such as one or more monitored services 110, anomaly detection services 120, and/or troubleshooting services 130. Monitored service 110 may be a source of data that is monitored, such as a network component or software service. Any source of data may be a monitored service 110, but some non-limiting examples may include service security key logins and/or service application programming interface (API) gateway tracking. Anomaly detection service 120 may perform the GAN model training and data analysis described herein on outputs of monitored service 110 to detect anomalies in the outputs that may indicate an issue or problem with monitored service 110. Results from anomaly detection service 120 may be provided to troubleshooting service 130, which may use the results to address the issue or problem with monitored service 110. In some embodiments, monitored service 110, anomaly detection service 120, and/or troubleshooting service 130 may be provided by one or more computers such as those illustrated in FIG. 10 and described in detail below. In some embodiments, monitored service 110, anomaly detection service 120, and/or troubleshooting service 130 may communicate with one another through a network (e.g., the Internet, another public and/or private network, or a combination thereof), or directly as subcomponents of a single computing device, or a combination thereof.

Anomaly detection service 120 may be configured to receive data from monitored service 110, process the data to make it suitable for analysis by a GAN, test the processed data using a GAN that may include one or more modifications, and scoring the test results to enable further processing by troubleshooting service 130.

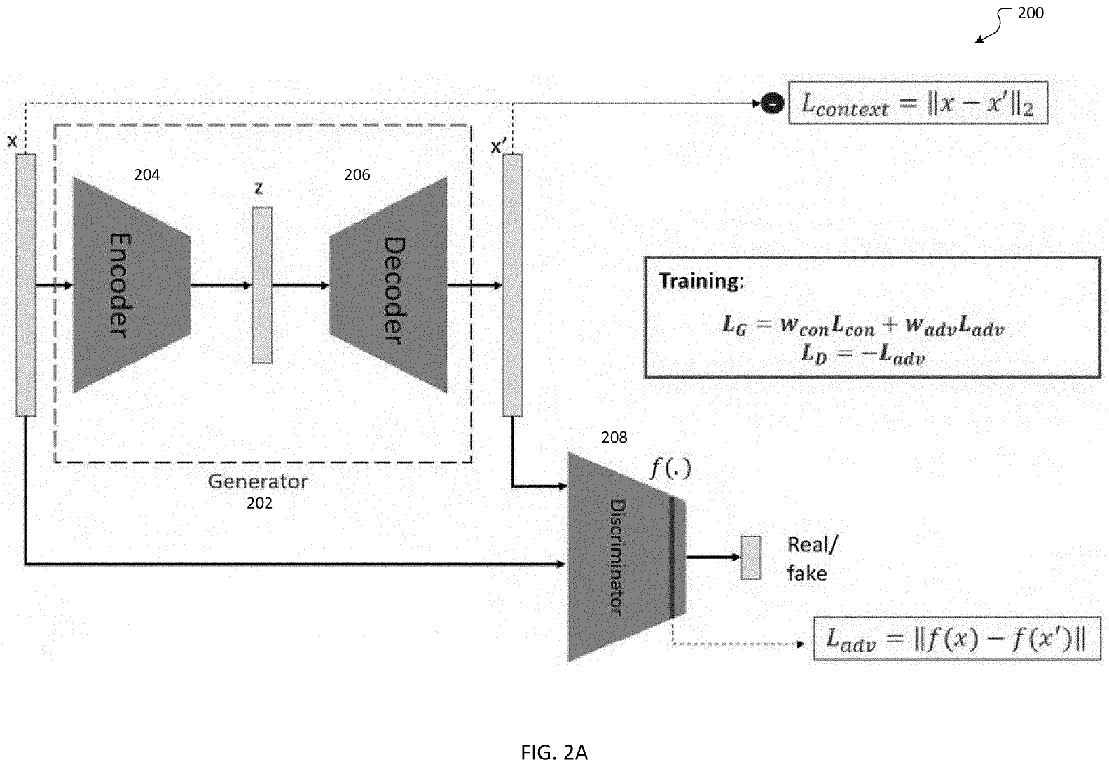

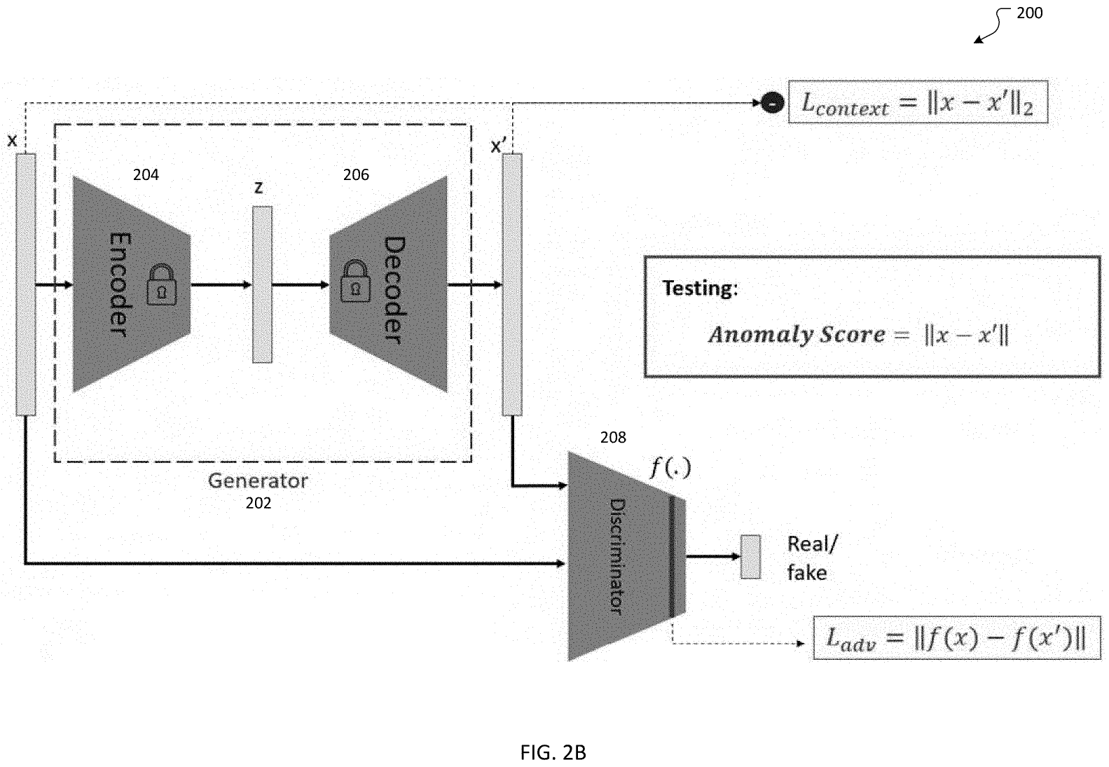

Accordingly, anomaly detection service 120 may include a GAN. FIGS. 2A-2B show a GAN 200 according to an embodiment of the present disclosure. GAN 200 is a deep neural network architecture hosted in a machine learning system, wherein two separate neural networks are trained and applied in an adversarial arrangement. These neural networks may include generator 202 and discriminator 208. Generator 202 may be, for example, a convolutional autoencoder, and discriminator 208 may be, for example, a convolutional neural network.

To understand the functioning of GAN 200, consider an example wherein GAN 200 is used in image processing. Generator 202 may receive input data x, which may include training data, for example, and may pass this input data x to its encoder 204. Encoder 204 may generate intermediate data z, which may be processed into output data x′ by decoder 206. In the context of the image processing example, encoder 204 and decoder 206 may apply known GAN algorithms to generate output data x′ that includes a new image (a “fake image”). Discriminator 208 may receive one batch of fake images and/or one batch of real images (e.g., input data x) and, by applying convolutional layers, compare the fake image to the one or more real images to determine whether the input image is fake (i.e., was generated by generator 202) or is real (i.e., was obtained from some source other than generator 202 such as a camera). In a GAN, an autoencoder-like structure of generator 202 may take data x as input and may train the whole network to generate x′ that is as similar as possible to input x. Discriminator 208 may take x or x′ as input and perform as a real/fake classifier. This way, as the training proceeds, generator 202 may get feedback from loss of discriminator 208, and generator 202 may use the feedback to get better and better at generating realistic images. Meanwhile, discriminator 208 may become more powerful in distinguishing real images from fake ones as it is exposed to more images. However, as described below, GANs may be applied to data other than image data through the use of embodiments described herein. For example, the assumption behind using GANs for anomaly detection is that training data may be clean and normal. Therefore, while testing the model with anomalous samples, the trained networks may fail to reconstruct x′ out of x and the loss value would be large.

When training, input data x may include a training set of multiple images used by discriminator 208 to compare with the fake image(s) from generator 202. The training may be done in batches. In each iteration (epoch), generator 202 and discriminator 208 may get a batch of data as input and train/optimize weights iteratively until all samples are used. Each generator 202 and discriminator 208 may have its own losses. Generator 202 may try to minimize the reconstruction loss while fooling discriminator 208 by minimizing the adversarial loss (the distance between abstracted features trained by the last layer of discriminator 208). Discriminator 208 may try to maximize the adversarial loss. In essence, this may be considered an adversarial process whereby generator 202 continuously learns to improve the similarity between its fake images and real images, while discriminator 208 continuously learns to improve its ability to distinguish fake images from real images. Backpropagation may be applied in both networks so that generator 202 produces better images, while the discriminator 208 becomes more skilled at flagging fake images. Relationships defining context loss (L_{context} or L_{con}), adversarial loss (L_{adv}), and overall generator loss (L_{G}) and discriminator loss (Lo) are shown in FIG. 2A.

Once GAN 200 has been trained, it may be applied to score anomalies in data. Using the image processing example, at least a portion of GAN 200 may be applied to score whether images are real or fake. For example, in some embodiments generator 202 may be used for determining an anomaly score: x-x′, while discriminator 208 may be used only for training, for example to help generator 202 train mappings optimally and converge faster, and may not be involved in testing procedures, as described below. As shown in FIG. 2B, scoring may be performed by fixing the encoder 204 and decoder 206 settings to the trained settings and passing input data x through generator 202, where input data x is the image being analyzed. The output of generator 202 may include an anomaly score representing a difference between input data x and output data x′. The trained networks of generator 202 may be used to determine anomalies. Assuming that GAN 202 was trained based on clean data, the amount of loss may be large in case of anomalous input. Accordingly, a threshold difference may be established, where images having an anomaly score below (or equal or below) the threshold are judged as not likely being anomalous, and images have an anomaly score equal or above (or above) the threshold are judged as being anomalous.

The basic GAN techniques of FIGS. 2A and 2B, and the underlying algorithms, have been applied and are known in the context of image anomaly detection. However, the embodiments described herein may apply GAN to other types of data. For example, in ecosystem 100, monitored service 110 may be a network server or component thereof that may process network traffic and/or requests from client devices. Outputs from monitored service 110 may therefore include one or more multivariate time series data sets, indicating information such as network traffic over time, system performance metrics over time, etc. In order to process these outputs using GAN 200, anomaly detection service 120 may be configured to perform input processing to convert multivariate time series data into one or more two-dimensional matrices or other data sets that may be processed similarly to two-dimensional images.

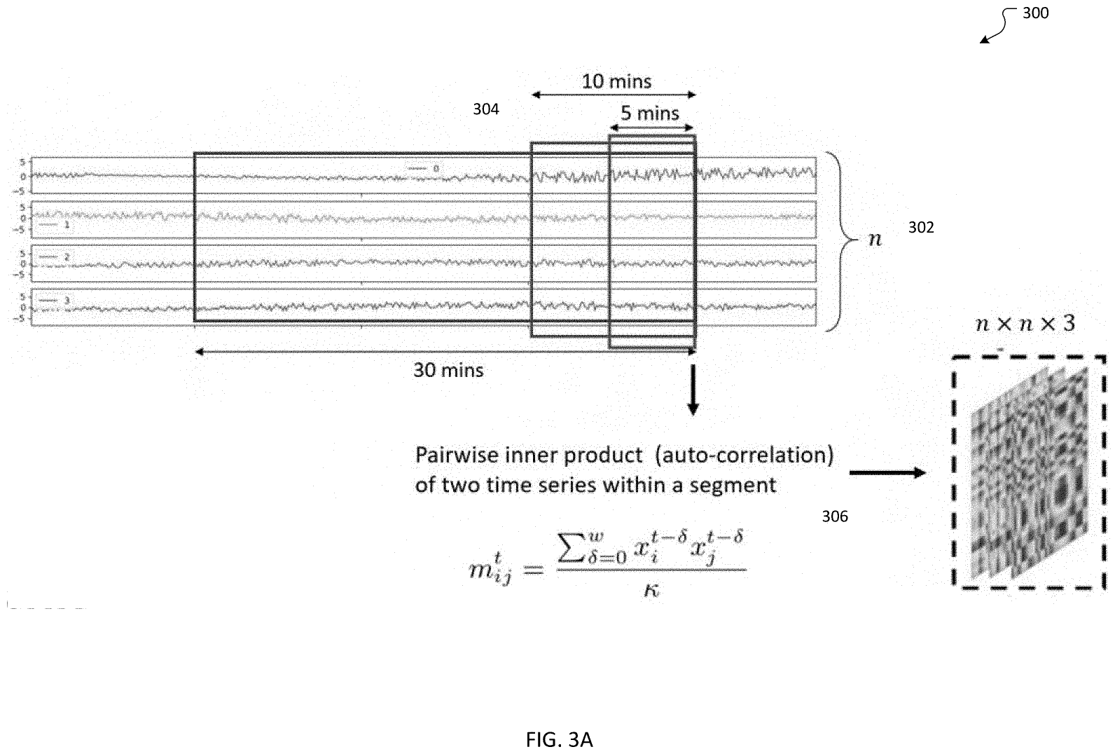

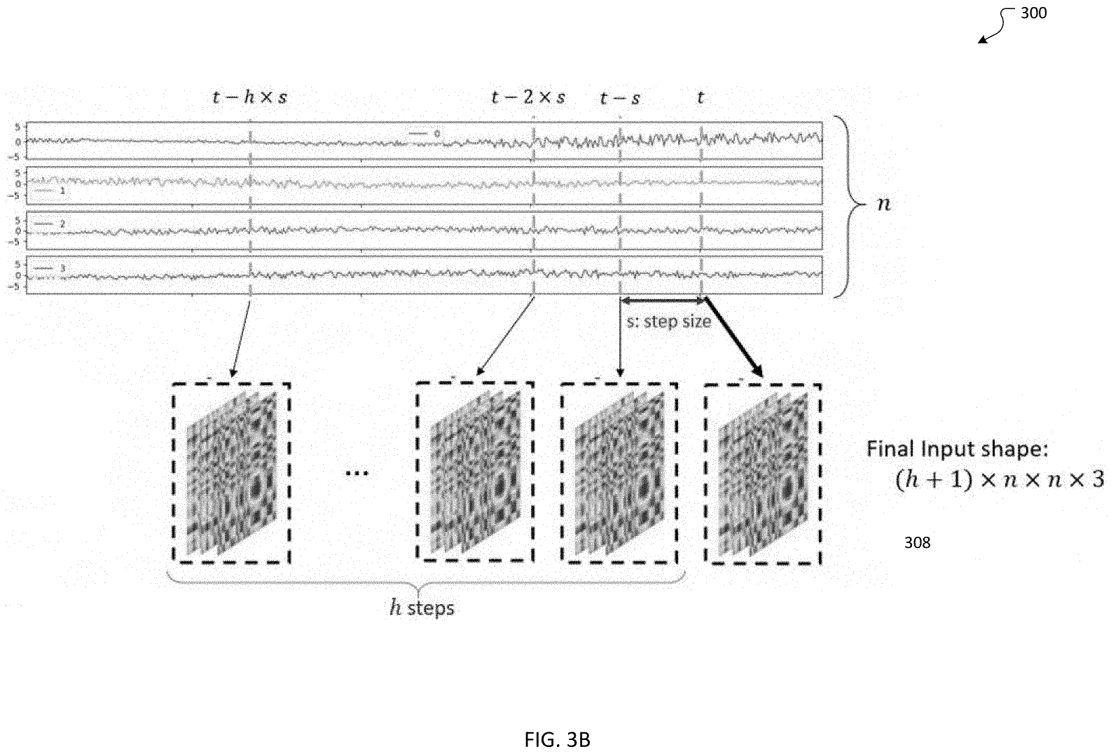

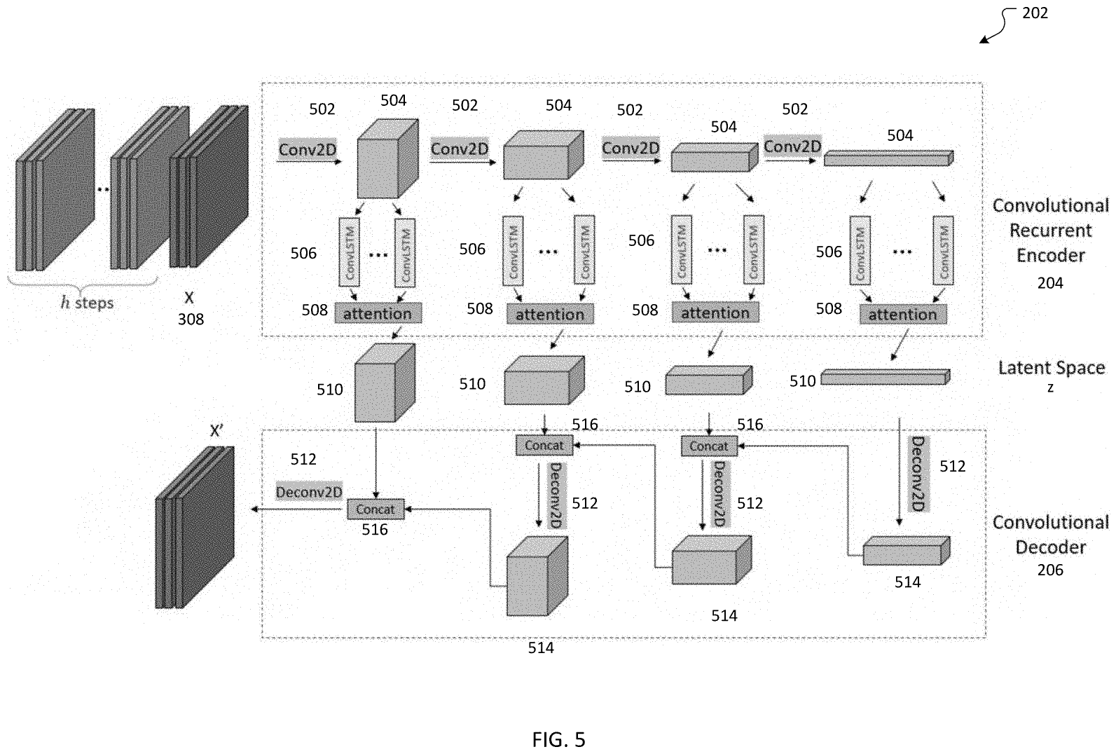

FIGS. 3A-3B show input data format processing 300 according to an embodiment of the present disclosure. Input data from monitored service 110 may include one or more sets 302 of multivariate time series data. Multivariate time series may be correlated time series captured from different sensors of a system. For example, API gateway data may include multiple time series sampled per minute, each representing the number of requests per minute, request size per minute, response time per minute, and so on. To be correlated, the time series have the same length and are arranged in a way that times are aligned. As shown in FIGS. 3A-3B, the sets 302 may be arranged as a set of graphs of the outputs over time in a vertical array of height n. Anomaly detection service 120 may sample the sets 302 over multiple moving time segments 304 (producing, in the example of FIGS. 3A-3B, 5 minute, 10 minute, and 30 minute segment samples).

As shown in FIG. 3A, anomaly detection service 120 may calculate a pairwise inner product of time series within a segment 304 to produce an n*n*3 “image” matrix 306. Matrix 306 may be suitable for processing by GAN 200. In some embodiments, as shown in FIG. 3B, matrix 306 may be further modified into a final input shape 308 for processing by GAN 200. This modification may include appending at least one matrix from at least one adjacent segment 304 to matrix 306 as shown. By appending an adjacent matrix, it may be possible to assemble a time sequence of the output corresponding to the time sequence of the multivariate time series data input. For example, this calculation may proceed as follows. First, it may be assumed that the entire time series related to training (or at least the entire time series for a time period of interest) is pulled from monitored service 110. Anomaly detection service 120 may generate signature (covariance) matrices (n*n) per each time step in training (every 5 minutes in the illustrated example) and per each predefined window size. Then, for a single time step, anomaly detection service 120 may generate three signature matrices associated with different window sizes. These three signature matrices may be used as three channels of image input. However, considering a single time step as input might not reflect the temporal dependency that exist between time steps. Therefore, anomaly detection service 120 may also append previous immediate h steps to the current time step as input, in order to reflect temporal dependencies. The final input of shape (h+1)*n*n*3 may be stored per time step and fed to GAN 200.

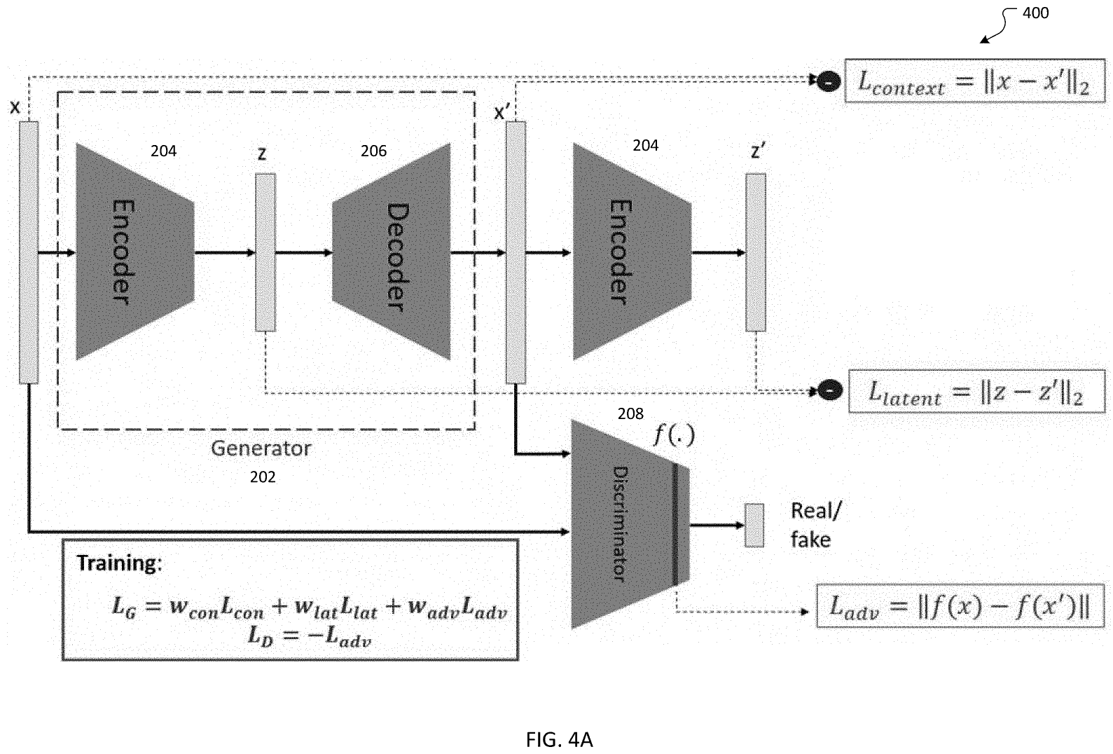

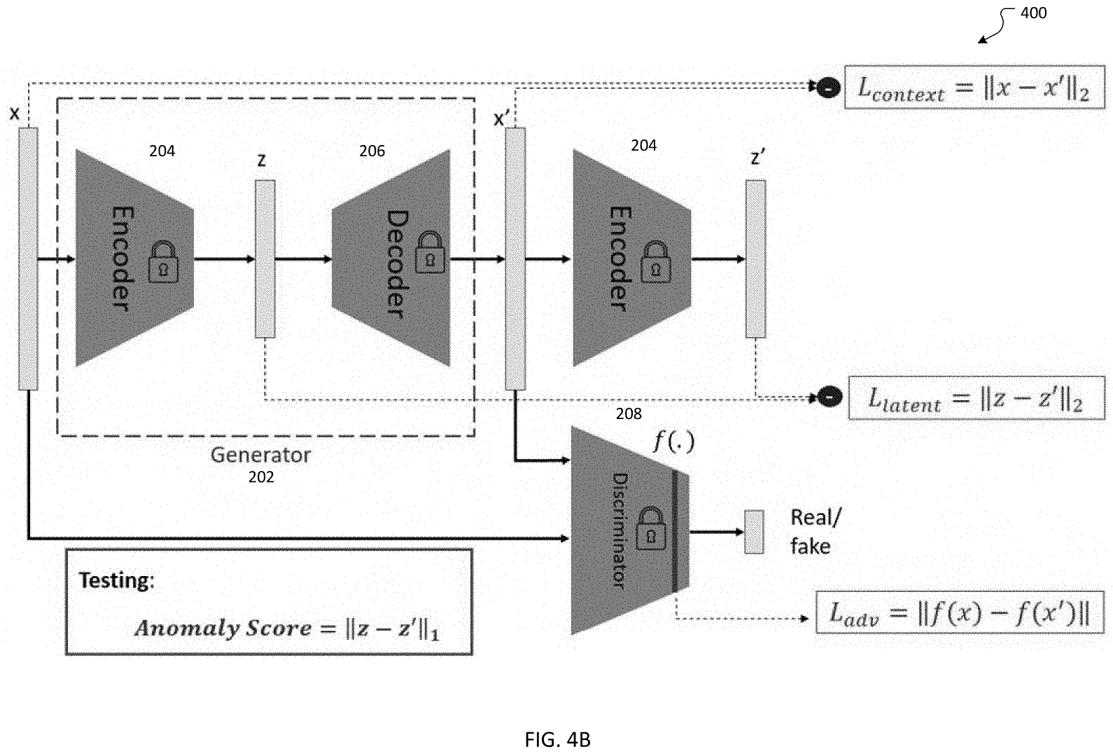

GAN 200 may be further modified to not be sensitive to, and to account for, noise present in the final input shape 308 including the multivariate time series information. For example, FIGS. 4A-4B show a GAN 400 configured to be robust against noise according to an embodiment of the present disclosure. In the embodiments described herein, it may be useful to maintain the integrity of the original multivariate time series information even when noise is present in final input shape 308. Accordingly, GAN 400 may include a second encoder 204 configured to further process the output of decoder 206. First and second encoders 204 may have the same internal structure and may therefore apply the same processing to inputs they respectively receive. The output of each encoder 204 may be a high-level representation of its input (which, in the case of the first encoder 204 inside generator 202, may be further processed by decoder 206 to create detailed output data x′), which is also known as “latent space.” It is expected that in case of anomalies, GAN 400 may map the input into feature spaces that are closer to a latent space of normal inputs. Therefore, by the addition of second encoder 204, GAN 400 may be enforced to optimize original and latent space representations jointly. In order to do that, an L2 distance between z and z′ may be added to the generator's loss function, wherein z and z′ are generated by a first convolutional layer in both encoders 204. These modifications may be applied to the network structure, and loss functions may be defined, before the training procedure starts. Accordingly, first encoder 204 output z within generator 202 and second encoder 204 output z′ generated using generator 202 output may be compared to determine latent loss (Latent) due to noise, according to the calculation shown in FIGS. 4A-4B.

For training, anomaly detection service 120 may use the stored image-like time steps generated in the preprocessing described above with respect to FIGS. 3A-3B as input, and the training procedure may be performed in batches. In each iteration, generator 2020 and discriminator 208 may train on fixed-size batches iteratively. After an iteration of training, anomaly detection service 120 may calculate the amounts of the generator's loss and the discriminator's loss based on the current network parameters. The training procedure may continue until both losses converge to a constant loss value, indicating that the losses cannot be optimized further. In essence, this may be considered an adversarial process whereby generator 202 continuously learns to improve the similarity between its output and the training set, while discriminator 208 continuously learns to improve its ability to distinguish generator 202 output from training set data. Backpropagation may be applied in both networks so that generator 202 produces better outputs, while the discriminator 208 becomes more skilled at flagging generator 202 outputs. In the embodiment of FIG. 4A, second encoder 204 may be trained at the same time jointly with generator 202. The training loss function may be modified as shown in FIG. 4A.

Once GAN 400 has been trained, it may be applied to score anomalies in data input as final input shape 308. As shown in FIG. 4B, this may be performed by fixing both encoder 204 settings, decoder 206 settings, and discriminator 208 setting to the trained settings and passing input data x through GAN 400, where input data x is the final input shape 308 being analyzed. The output of GAN 400 may include a residual matrix representing a difference between input data x and output data x′ and/or a residual matrix representing a difference between z and z′. An anomaly score may be generated based on these matrices, and a threshold difference may be established, where data having an anomaly score below (or equal or below) the threshold are judged as not likely being anomalous, and data have an anomaly score equal or above (or above) the threshold are judged as being anomalous.

While many kinds of anomalies may be detectable in this way, in some embodiments anomalous data may refer to time steps in final input shape 308 with abnormal values and/or abnormal correlations between time series in final input shape 308. The trained GAN 400 may be used for testing new samples and detecting anomalous time steps. For each input x of the final input shape 308 in a test set, an output z, x′, and z′ may be generated by the generator's network. The L2 distance between x and x′ and the L2 distance between z and z′ may be calculated and used for score assignment. Abnormal patterns in input data may result in large reconstruction error that is reflected in contextual and latent loss.

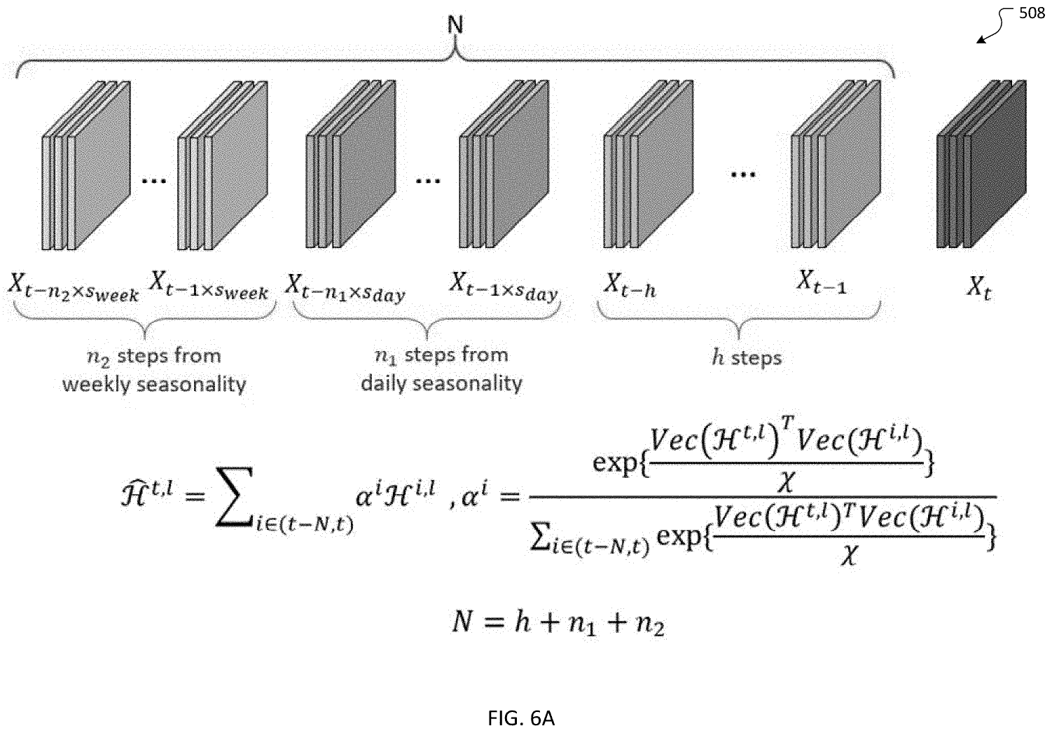

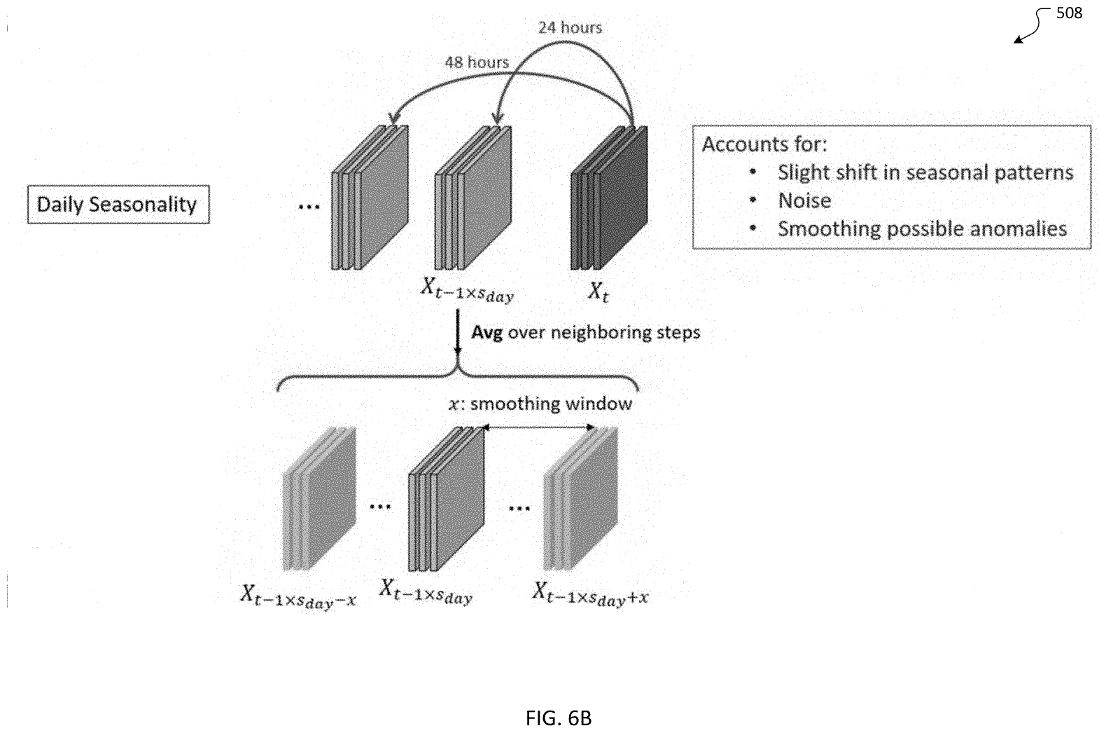

GAN 400 may be further modified to be sensitive to seasonalities in the input multivariate time series information. For example, time series data may exhibit patterns of activity that may be deviant from average patterns but that recur at predictable times, such as surges in network traffic at the start of each business day, or the like. Generator 202 of GAN 400 may be configured to account for these seasonal patterns. FIG. 5 shows a generator 202 of a GAN 400 including an attention mechanism according to an embodiment of the present disclosure, where the attention mechanism accounts for seasonal patterns before anomaly scoring is performed. As shown, encoder 204 may include several two-dimensional convolutional layers 502 that may process data in succession. For example, a first convolutional layer 502 may process the raw final input shape 308 and produce a spatial convolution output 504, which may in turn be processed by the next convolutional layer 502, whose output 504 may be processed by the next convolutional layer 502, and so on until all convolutional layers 502 in encoder 204 have generated outputs 504. However, instead of providing these outputs 504 to decoder 206 as intermediate latent data z, encoder 204 may perform additional processing on each output 504. For example, each output 504 may be fed through one or more convolutional long short-term memory (LSTM) networks or gates 506, and the outputs of the convolutional LSTM networks or gates 506 may be fed to one or more attention mechanisms 508 which may be configured to capture seasonality as described below with respect to FIGS. 6A-6B. The outputs 510 of each attention mechanism 508 may be provided to decoder 206 as intermediate latent data z. Decoder 206 may perform two-dimensional decoding 512 on each of the outputs 510 and/or a concatenation 516 of previously decoded data 514 and an output 510, until all output 510 data is decoded and concatenated as shown in FIG. 5 to produce x′.

Specifically, in some embodiments, the processing performed by generator 202 of FIG. 5 may proceed as follows. Each convolutional layer 502 may capture spatial dependencies of input in different levels of abstraction. Since the structure of the input may include temporal dependencies, each output 504 may be further processed by a sequence of convolutional LSTM gates 506. These LSTM gates 506 may be added to the network structure (graph) with input/output architecture as illustrated in FIG. 5. For example, each h+1 step may be fed to each layer 502, and the output of each layer 502 may be further fed to an LSTM gate 506. The structure of LSTM may allow the model to capture temporal dependencies between the current time step and all the previous h steps. While the original LSTM gate 506 may treat all previous (immediate or seasonal) steps the same, it may be useful to pay more attention to some specific steps. By applying the attention mechanism 508, generator 202 may automatically decide which step is more relevant (in this case, has closer distance in hidden layer) to the current time step, and reconstruct the current time step based on this weight. The convolutional decoder may apply multiple deconvolutional layers 512 in order to map the hidden state to reconstruct the input. This procedure may start from the most abstract component of latent space, apply deconvolutional layer 512, and concatenate the output of this deconvolutional layer 512 with the next latent component as input to the next deconvolutional layer 512.

FIGS. 6A-6B show an attention mechanism 508 according to an embodiment of the present disclosure. Specifically, FIGS. 6A-6B illustrate the internal structure of attention mechanism 508, including the algorithm performed by attention mechanism 508 to account for seasonality of data (FIG. 6A) and to smooth noise caused by slight shifting in seasonal patterns (e.g., traffic flow patterns changing after a daylight savings time change or the like), noise, and/or anomaly (FIG. 6B). Attention mechanism 508 may be applied to the output of the hidden layer of convolutional LSTM gates 506 based on a similarity measure calculated by the formula mentioned in FIG. 6A. This procedure may assign more weight to the time steps that are more similar to the current (last) step. This way, the model may pay more attention to the previous seasonal patterns rather than previous immediate steps. The model may learn such weights as the training proceeds. However, a seasonal pattern in data might be shifted by a few steps or some noise/anomalies might exist in such steps. Therefore, instead of only one time-step, attention mechanism 508 may calculate an average over a neighboring window and feed the average as input for previous seasonal steps.

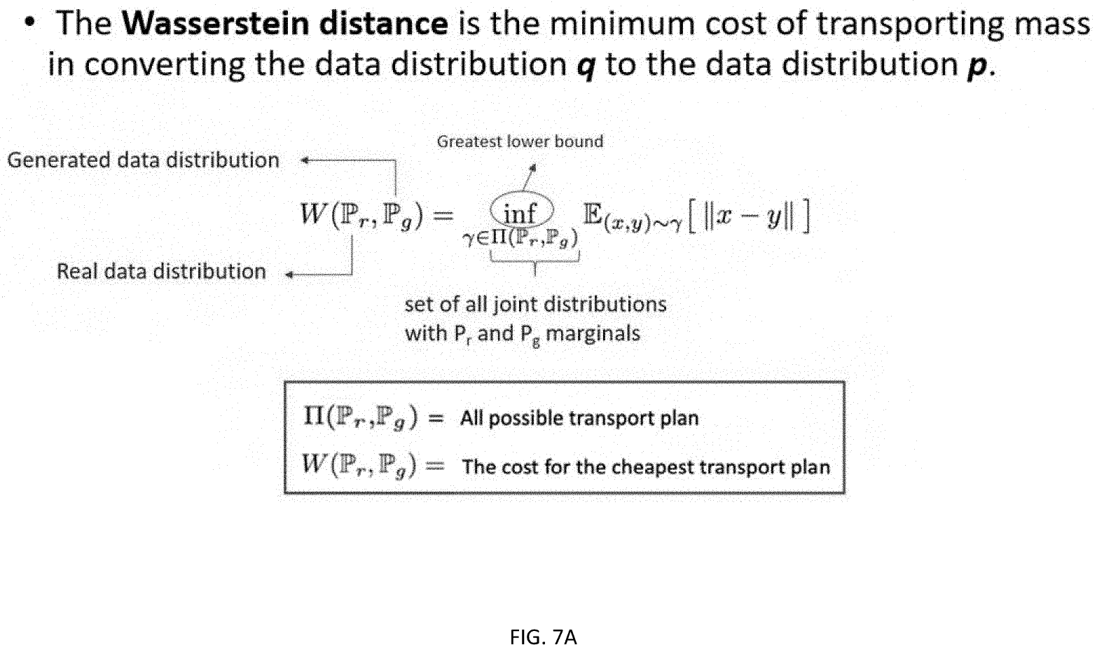

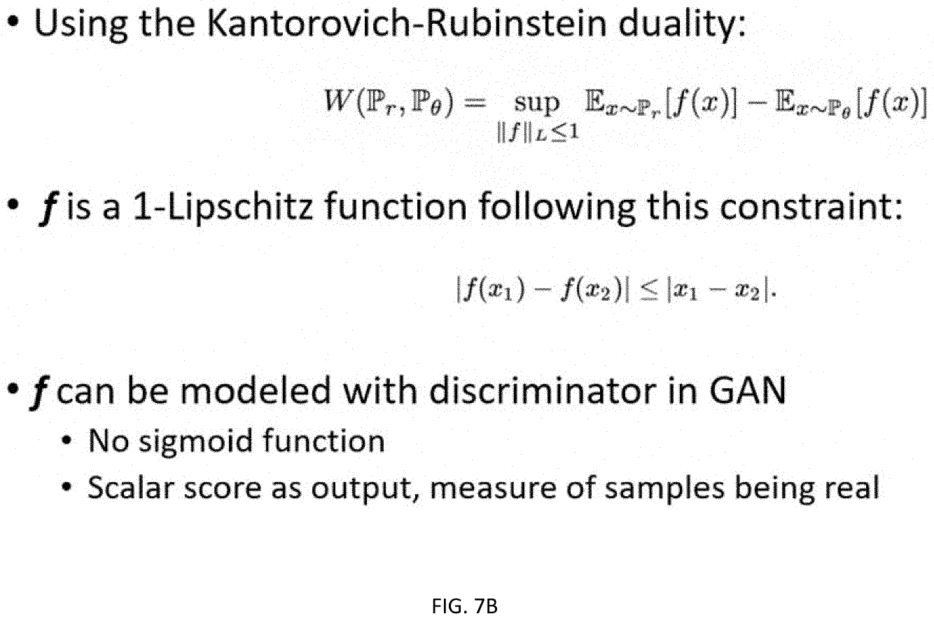

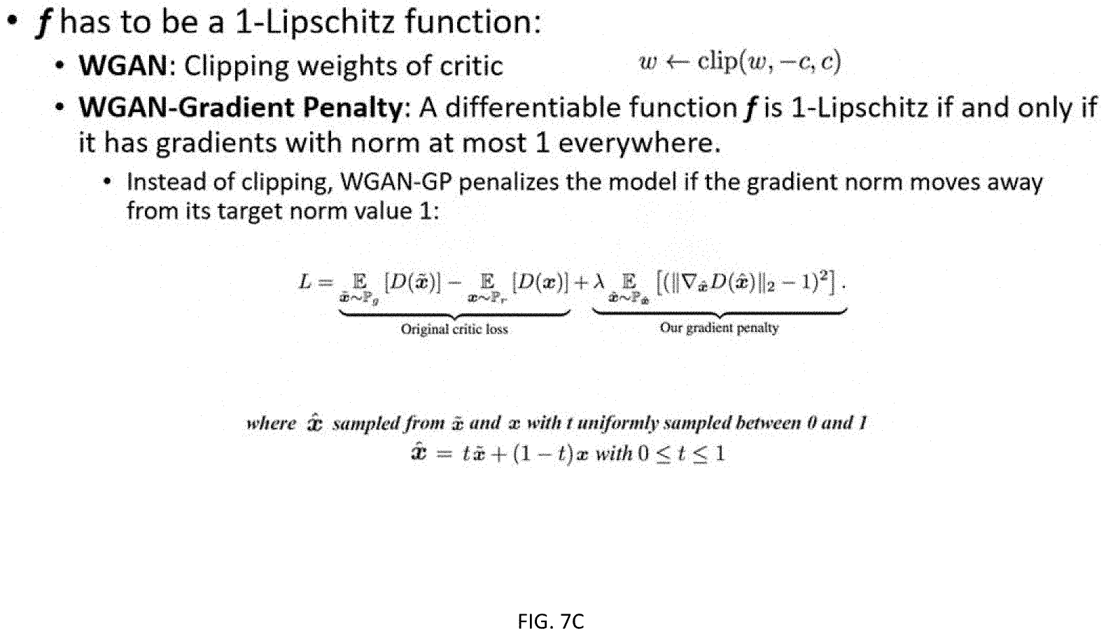

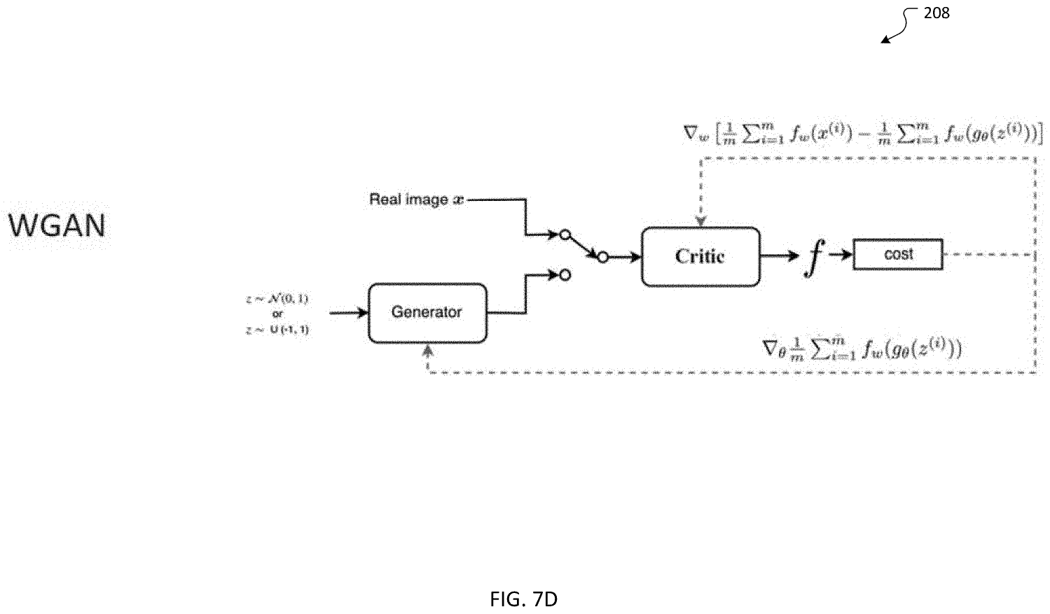

In some embodiments, the performance and/or trainability of discriminator 208 may be enhanced by configuring discriminator 208 to use a Wasserstein function. FIGS. 7A-7D describe a Wasserstein function used by a discriminator 208 of a GAN 400 according to an embodiment of the present disclosure. Specifically, FIGS. 7A-7C explain some features of the Wasserstein function as applied to GAN 400, and FIG. 7D shows discriminator 208 configured to use the Wasserstein function. Wasserstein is a loss function defined to calculate the distance between two distributions. Simplification of the formula in FIG. 7A gives the formula in FIG. 7B, with constraints mentioned in FIG. 7B. On the other hand, the role of discriminator 208 is to maximize the distance between two distributions of real and fake data. Therefore, the whole objective of discriminator 208 (previously adversarial loss) may be performed by the Wasserstein distance function. In order to enforce the aforementioned constraint, discriminator 208 may apply a gradient penalty that may help control the power of discriminator 208 and that may therefore result in more stable training. Accordingly, the Wasserstein distance function may provide an improvement in training and convergence time.

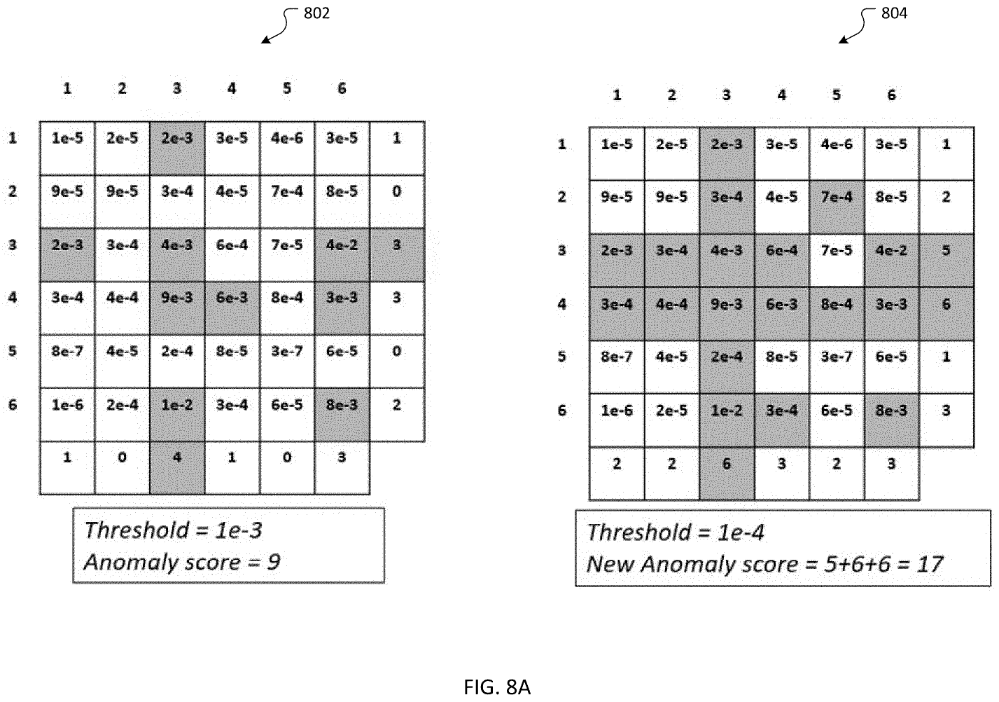

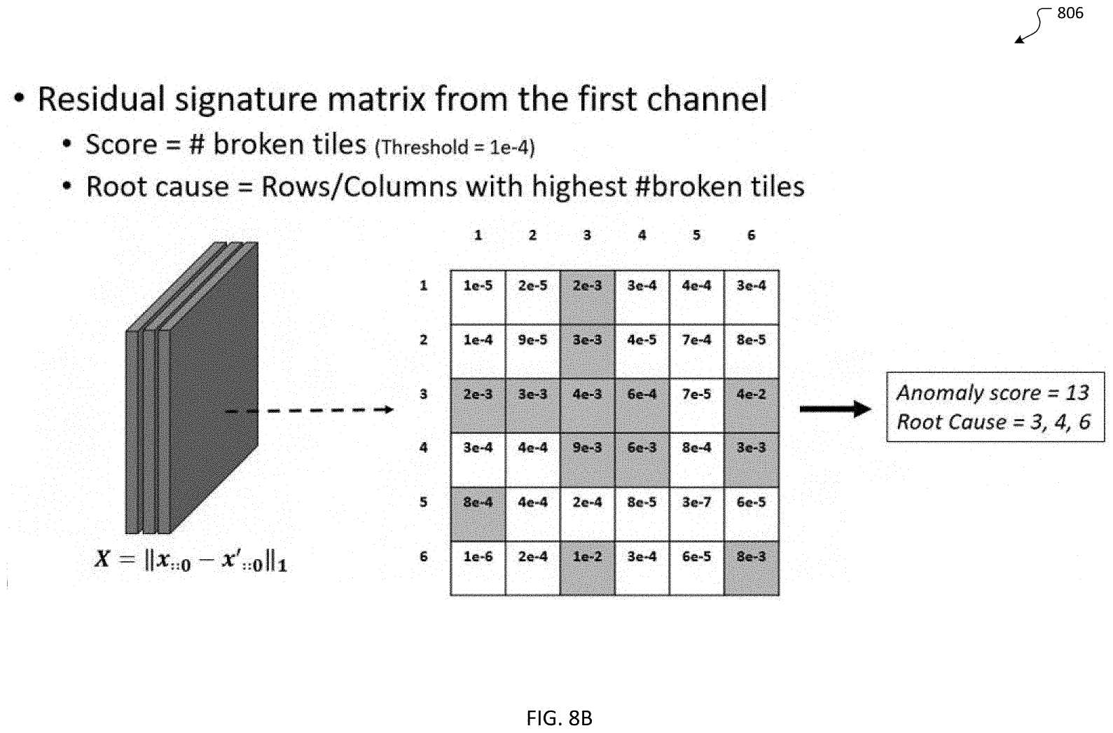

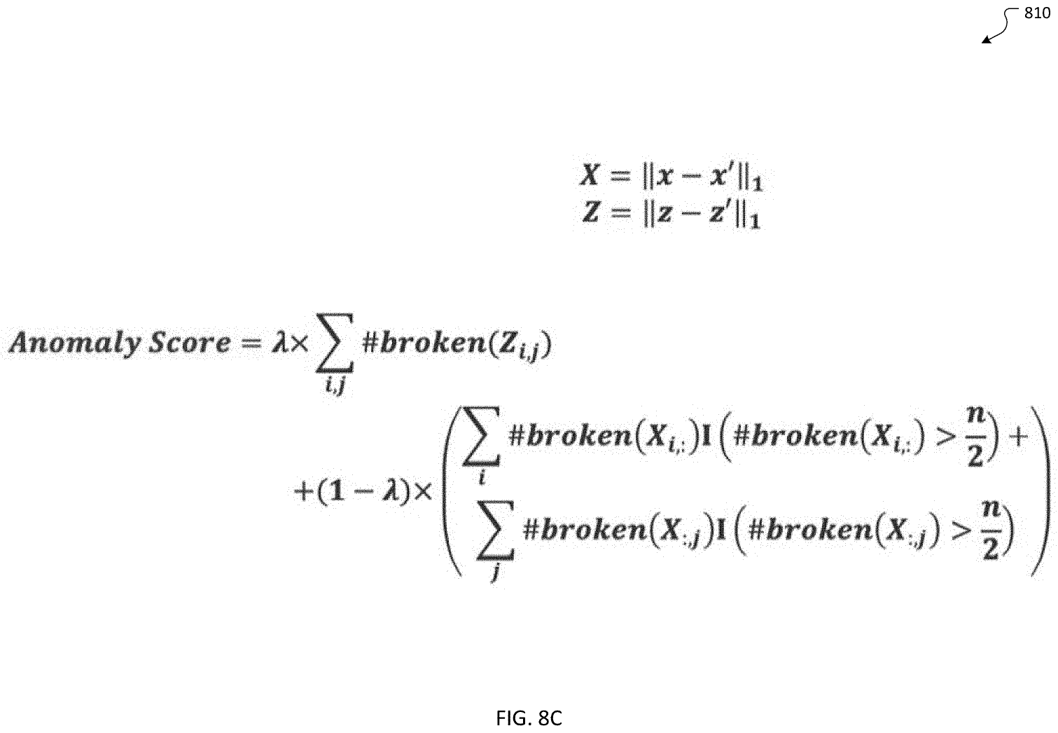

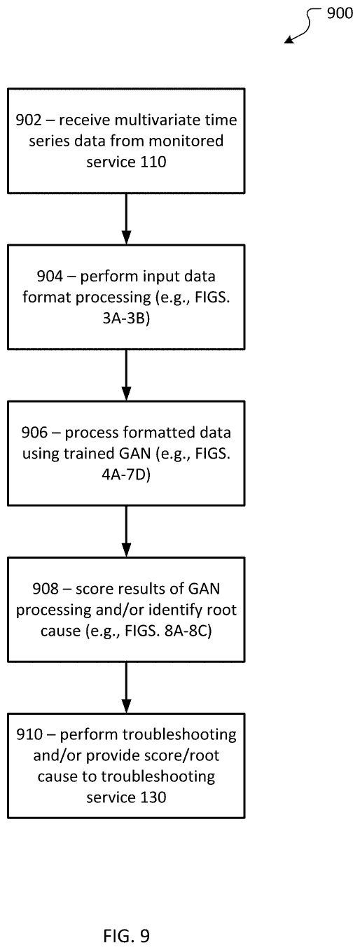

In some embodiments, output of GAN 400 may be processed to indicate the presence of one or more anomalies, which may include scoring anomalies, and/or to identify one or more root causes of the one or more anomalies. FIGS. 8A-8C show anomaly score assignment and root cause identification according to an embodiment of the present disclosure.

For example, FIG. 8A compares two possible anomaly scoring techniques for scoring a same GAN 400 output. The output may be a matrix (here, a 6*6 matrix, though any n*n matrix may be possible), with each x*y tile in the matrix having a particular value determined by GAN 400, as shown. This matrix may be a residual matrix, calculated by L2 distance between input x and output x′. Each row/column in this matrix may represent the amount of error that occurred in reconstruction of that time series. As discussed above, if the input includes n time series, then the residual matrix may have shape n*n. In the first scored matrix 802, the threshold for flagging a matrix tile as indicating an anomaly may be relatively high, but all anomalies may be counted, giving in this example an anomaly score of 9 for the matrix 802. In the second scored matrix 804, the threshold for flagging a matrix tile as indicating an anomaly may be significantly less than in the first scored matrix 802. This may increase score sensitivity, but may also increase the risk of false positives. To guard against false positives, anomalies may only be counted when more than half the tiles in a row or a column of matrix 804 include anomalies, which may increase score confidence. So, in the illustrated example, anomalies in rows 3 and 4 and in column 3 are counted while others are ignored, resulting in an anomaly score of 17 in this example. Accordingly, scoring using the scheme applied to matrix 804 may result in more sensitive anomaly detection that is also noise tolerant.

Moreover, as shown in FIG. 8B, the scoring scheme applied to matrix 804 may be used to identify root causes of the anomaly. While the overall anomaly score may be based on a total number of broken tiles that are counted within matrix 806, it may be the case that more of the broken tiles come from one or more particular rows or columns. Because the data being analyzed may include multivariate time series data, as described above, for a specific time step as input, the anomaly detection algorithm may assign a single score and may specify the time series that contributed to the anomaly (if the score is greater than a threshold). The columns/rows associated with large errors may be identified and/or labeled as root cause(s). Specifically, adding up the amount of error in one or more rows with each row's corresponding column(s) may result in n scores, each associated with a time series in input. The higher the score, the more contribution the time-series has to the anomaly. Accordingly, high scoring rows and columns for a specific time point in the test set may be related to the root cause of anomalies.

An anomaly score equation 810 may be as expressed in FIG. 8C in some embodiments.

Based on the above-described techniques, anomaly detection service 120 may identify anomalies in monitored service 110, and troubleshooting service 130 may troubleshoot the identified anomalies. FIG. 9 shows an anomaly detection process 900 according to an embodiment of the present disclosure. A computing device or plurality of computing devices configured to operate anomaly detection service 120 and/or troubleshooting service 130 (e.g., as described below with respect to FIG. 10) may perform process 900 to evaluate data provided by monitored service 110 and address anomalies in the data.

At 902, anomaly detection service 120 may receive multivariate time series data from monitored service 110. While this is depicted as a discrete step for ease of illustration, in some embodiments monitored service 110 may continuously or repeatedly report data, and accordingly process 900 may be performed iteratively as new data becomes available.

At 904, anomaly detection service 120 may perform input data format processing. For example, anomaly detection service 120 may perform the processing described above with respect to FIGS. 3A-3B to create a final input shape 308 of suitable format for processing by a GAN (e.g., GAN 400).

At 906, anomaly detection service 120 may process data generated at 904 using a trained GAN, such as GAN 400. As described above with respect to FIGS. 4A-7D, GAN 400 may be configured to find anomalies in multivariate time series data and may be trained on sample multivariate time series datasets. Accordingly, anomaly detection service 120 may apply final input shape 308 to GAN 400 to thereby generate a matrix of data with tiles having GAN-determined values.

At 908, anomaly detection service 120 may score the results of processing at 906 to generate an anomaly score for the multivariate time series data from monitored service 110 and/or a root cause identification for any detected anomalies in the multivariate time series data. for example, anomaly detection service 120 may perform the processing described above with respect to FIGS. 8A-8C to identify anomalies and/or root causes.

At 910, anomaly detection service 120 and/or troubleshooting service 130 may perform troubleshooting (e.g., a remedial action) to address any anomalies detected at 908. For example, anomaly detection service 120 may be used to monitor data pipeline issues and potential cyber-attacks. After anomaly detection service 120 detects an anomaly, troubleshooting service 130 may alert analysts and data engineers for troubleshooting. Also, pinpointing the root cause by anomaly detection service 120 may help analysts identify the affected time series and/or may allow troubleshooting service 130 to route the alert to appropriate specialists who understand the root cause or apply automatic mitigation targeted to the root cause (e.g., rebooting malfunctioning systems identified as root causes, taking the identified malfunctioning systems offline, etc.).

FIG. 10 shows a computing device according to an embodiment of the present disclosure. For example, computing device 1000 may provide anomaly detection service 120, troubleshooting service 130, or a combination thereof to perform any or all of the processing described herein. The computing device 1000 may be implemented on any electronic device that runs software applications derived from compiled instructions, including without limitation personal computers, servers, smart phones, media players, electronic tablets, game consoles, email devices, etc. In some implementations, the computing device 1000 may include one or more processors 1002, one or more input devices 1004, one or more display devices 1006, one or more network interfaces 1008, and one or more computer-readable mediums 1010. Each of these components may be coupled by bus 1012, and in some embodiments, these components may be distributed among multiple physical locations and coupled by a network.

Display device 1006 may be any known display technology, including but not limited to display devices using Liquid Crystal Display (LCD) or Light Emitting Diode (LED) technology. Processor(s) 1002 may use any known processor technology, including but not limited to graphics processors and multi-core processors. Input device 1004 may be any known input device technology, including but not limited to a keyboard (including a virtual keyboard), mouse, track ball, and touch-sensitive pad or display. Bus 1012 may be any known internal or external bus technology, including but not limited to ISA, EISA, PCI, PCI Express, NuBus, USB, Serial ATA or FireWire. Computer-readable medium 1010 may be any medium that participates in providing instructions to processor(s) 1002 for execution, including without limitation, non-volatile storage media (e.g., optical disks, magnetic disks, flash drives, etc.), or volatile media (e.g., SDRAM, ROM, etc.).

Computer-readable medium 1010 may include various instructions for implementing an operating system 1014 (e.g., Mac OS®, Windows®, Linux, Android®, etc.). The operating system may be multi-user, multiprocessing, multitasking, multithreading, real-time, and the like. The operating system may perform basic tasks, including but not limited to: recognizing input from input device 1004; sending output to display device 1006; keeping track of files and directories on computer-readable medium 1010; controlling peripheral devices (e.g., disk drives, printers, etc.) which can be controlled directly or through an I/O controller; and managing traffic on bus 1012. Network communications instructions 1016 may establish and maintain network connections (e.g., software for implementing communication protocols, such as TCP/IP, HTTP, Ethernet, telephony, etc.), for example including receiving data from monitored service 110 and/or sending data to troubleshooting service 130.

Pre-processing instructions 1018 may include instructions for implementing some or all of the pre-processing described herein, such as converting multivariate time series data into a format that can be processed by a GAN. GAN instructions 1020 may include instructions for implementing some or all of the GAN-related processing described herein. Scoring instructions 1022 may include instructions for implementing some or all of the anomaly scoring processing described herein.

Application(s) 1024 may be an application that uses or implements the processes described herein and/or other processes. For example, one or more applications may the results of anomaly detection service 120 processing (e.g., pre-processing, GAN, and/or scoring) to perform troubleshooting on the identified anomalies. The processes may also be implemented in operating system 1014.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java, JavaScript), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a Random Access Memory (RAM) or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer. In some embodiments, the computer may have audio and/or video capture equipment to allow users to provide input through audio and/or visual and/or gesture-based commands.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method of detecting an anomaly comprising:
receiving, by an anomaly detection service executed by a processor, multivariate time series data;
formatting, by the anomaly detection service executed by the processor, the multivariate time series data into a final input shape configured for processing by a generative adversarial network (GAN);
generating, by the anomaly detection service executed by the processor, a residual matrix by applying the final input shape to a generator of the GAN, the residual matrix comprising a plurality of tiles;
scoring, by the anomaly detection service executed by the processor, the residual matrix by identifying at least one tile of the plurality of tiles having a value beyond a threshold indicating the anomaly; and
performing, by the processor, at least one remedial action for the anomaly in response to the scoring.

2. The method of claim 1, wherein the scoring further comprises:
determining that a number of identified tiles having values beyond the threshold in a single row or column of the residual matrix is at least half a total number of tiles in the single row or the column; and
identifying the single row or the column as being associated with a root cause of the anomaly in response to the determining.

3. The method of claim 2, wherein:
the residual matrix comprises a plurality of rows and columns, each associated with a respective subset of the multivariate time series data; and
the identifying comprises labeling the respective subset associated with the identified row or column as the root cause.

4. The method of claim 2, wherein the at least one remedial action is selected based on the root cause.

5. The method of claim 1, wherein the formatting comprises:
selecting a plurality of signature matrices associated with different window sizes of the multivariate time series data;
generating an image matrix by calculating a pairwise inner product of the plurality of signature matrices for a first time step; and
appending at least one image matrix from at least one previous time step to the image matrix.

6. The method of claim 1, wherein generating the residual matrix comprises identifying at least one temporal dependency within the final input shape using convolutional long short-term memory.

7. The method of claim 6, wherein generating the residual matrix further comprises determining at least one relevance of the at least one temporal dependency using an attention module, the at least one relevance indicating a seasonality indicated by the final input shape.

8. The method of claim 7, wherein the scoring ignores the seasonality in identifying the anomaly.

9. A system for detecting an anomaly comprising:
a processor configured to execute an anomaly detection service to perform the following processing:
receive multivariate time series data;
format the multivariate time series data into a final input shape configured for processing by a generative adversarial network (GAN);
generate a residual matrix by applying the final input shape to a generator of the GAN, the residual matrix comprising a plurality of tiles; and
score the residual matrix by identifying at least one tile of the plurality of tiles having a value beyond a threshold indicating an anomaly;
wherein the processor is further configured to perform at least one remedial action for the anomaly in response to the scoring.

10. The system of claim 9, wherein the scoring further comprises:
determining that a number of identified tiles having values beyond the threshold in a single row or column of the residual matrix is at least half a total number of tiles in the row or column; and
identifying the row or column as being associated with a root cause of the anomaly in response to the determining.

11. The system of claim 10, wherein the at least one remedial action is selected based on the root cause.

12. The system of claim 10, wherein:
the residual matrix comprises a plurality of rows and columns, each associated with a respective subset of the multivariate time series data; and
the identifying comprises labeling the respective subset associated with the identified row or column as the root cause.

13. The system of claim 9, wherein the formatting comprises:
selecting a plurality of signature matrices associated with different window sizes of the multivariate time series data;
generating an image matrix by calculating a pairwise inner product of the plurality of signature matrices for a first time step; and
appending at least one image matrix from at least one previous time step to the image matrix.

14. The system of claim 9, wherein generating the residual matrix comprises identifying at least one temporal dependency within the final input shape using convolutional long short-term memory.

15. The system of claim 14, wherein generating the residual matrix further comprises determining at least one relevance of the at least one temporal dependency using an attention module, the at least one relevance indicating a seasonality indicated by the final input shape.

16. The system of claim 15, wherein the scoring ignores the seasonality in identifying the anomaly.

17. A method of training a machine learning system including a generative adversarial network (GAN) for anomaly detection, the method comprising:
receiving, by a processor, a plurality of multivariate time series data sets;
formatting, by the processor, each of the plurality of multivariate time series data sets into respective final input shapes configured for processing by the GAN, the GAN comprising a generator and a discriminator;
training, by the processor, the GAN using the final input shapes; and
deploying, by the processor, the generator of the GAN to detect an anomaly in a separate multivariate time series data set after the training.

18. The method of claim 17, wherein the generator comprises an encoder configured to generate latent space data and a decoder configured to process the latent space data, the method further comprising training a second encoder identical to the encoder to minimize latent loss in the latent space data.

19. The method of claim 18, wherein the deploying comprises determining an anomaly score based on the latent loss associated with the separate multivariate time series data.

20. The method of claim 17, wherein the discriminator is configured to discriminate generator output from the final input shapes using a Wasserstein function.
